(19) United States
(12) Patent Application Publication
(10) Pub. No.: US 2006/0129878 A1
(43) Pub. Date: Jun. 15, 2006

(54) Computer restoration method

(76) Inventors: Carlos Soto, Morgan Hill, CA (US); Jonas Irwin, Livermore, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 10/995,065

(22) Filed: Nov. 22, 2004

(51) Int. Cl. G06F 11/00

(52) U.S. Cl. 714/7

(57) ABSTRACT

A method is provided for restoring and configuring a replacement computer of different type or brand or an original computer with a change in hardware. As disclosed by the invention, all the drivers available in the operating system are turned on by an agent software application if the replacement computer is found to be of a new type or brand, or if the backed up restoration information does not work for all the hardware. Thus, the restoration or configuration process can go smoothly with minimum human involvement.

### FIELD OF THE INVENTION

The present invention relates to computer restoration techniques, and more particularly, to a method and system for configuring a replacement computer of a different type or brand than that being replaced, and for restoring a computer in which some hardware has changed.

### BACKGROUND OF THE INVENTION

A restoration service provider backs up desired restoration information of a client computer which can be later used for restoring the client computer or for configuring a replacement computer. Such desired restoration information may include hardware configurations, installed software applications and their settings, data files, and other information associated with the client computer. It may even back up all the data in the entire hard drive and advantageously store it as an image of the hard drive. Preferably, as illustrated in FIG. 1, the restoration information is saved in a nonvolatile storage 11 of a server 10 of the service provider, which is remotely located from the client computer 20 and communicates with the client computer 20 over a data connection 12 such as the Internet or a local area network (LAN).

When the client computer 20 needs to be restored (e.g., after it crashes), the restoration information backed up in the server 10 is downloaded to the client computer 20 for restoration. If the client computer 20 is replaced by a new computer, the restoration information can be used to configure the new replacement computer in a manner identical same as that of the replaced one. This significantly saves labor and time for restoring the client computer or configuring the replacement computer.

However, if the client computer 20 is replaced by a computer of a different type or brand, some drivers that worked properly for the original (replaced) computer may not work for the new (replacement) computer because they are hardware specific. Thus, the driver information in the backed up restoration information may not be useful to configure a replacement computer if the replacement computer is of a different type or brand. Similarly, if some hardware of the client computer 20 is replaced with hardware of new model or brand, the restoration information may not work for all the hardware. In such situations, more human involvement is unavoidable.

Thus, there exists a need for a solution for efficiently and automatically configuring a replacement computer of a different type or brand from that of the original computer to be replaced, or a client computer in which some hardware has changed.

### SUMMARY OF THE INVENTION

The present invention provides a method and system for restoring or configuring a client computer in which the restoration information obtained from an original computer is saved in a server and is provided to a client computer for restoration or configuration. In particular, as taught by the present invention, all the drivers available in an operating system in said client computer are turned on and fully activated. The backed up version of the client computer information contains fully activated drivers for various types and brands of hardware, even those not operable with the type or brand of hardware being used as the client computer. If a new type or brand of computer replaces the client computer, then the backed up version of the client computer information will still be operable, as long as the drivers associated with the new type or brand of computer are supported by the operating system.

### BRIEF DESCRIPTION OF THE DRAWINGS

The above and other features and advantages of the present invention will be clearer by reading the detailed description of preferred embodiments of the present invention with reference to the accompanying drawings, in which:

FIG. 1 is a schematic illustration of the restoration backup system of prior art;

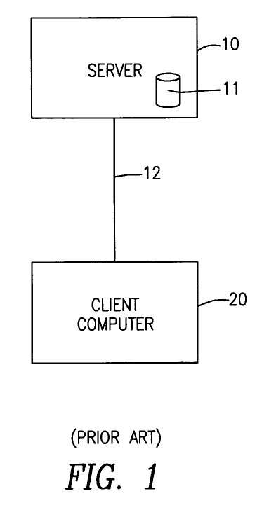

FIG. 2 is a schematic illustration of the restoration backup system according to the present invention;

FIG. 3 is a flow chart illustrating an embodiment according to the present invention; and

FIG. 4 is a flow chart illustrating another embodiment according to the present invention.

### DETAILED DESCRIPTION OF THE INVENTION

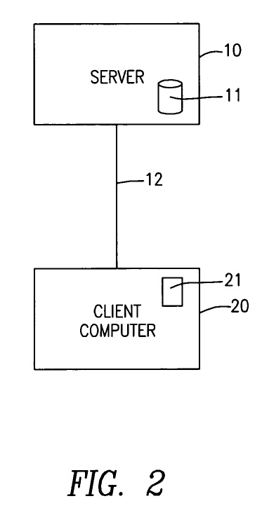

As schematically illustrated in FIG. 2, the restoration backup system of the present invention comprises a server 10 to backup restoration information at a nonvolatile storage 11 for a client computer 20. Preferably, the server 10 is remotely located from the client computer 20 and communicates with the client computer 20 over a data connection 12, such as Internet or LAN, to provide restoration backup service. The client computer 20 may be a workstation or server in a network which may also receive other services from the service provider that manages the backup server 10.

The restoration information backed up in the storage 11 is obtained from an original computer, which may be the client computer 20 itself or may be a previous computer replaced by the client computer 20. Therefore, the restoration information can be provided to the client computer 20 either to restore it to have the previous configuration and settings if it was the same computer as the original one, or to configure the client computer 20 to have the same configuration and settings as those of the original computer replaced by the client computer 20. However, when some hardware in the client computer 20 has changed, or when the client computer 20 is of a different type or brand from that of the original computer, the driver information in the restoration information may not work for this new hardware because many drivers are hardware specific. Even though the drivers for this new hardware are available in the operating system, such as Windows, they are normally not turned on. Instead, only the drivers specific to the hardware in which the operating system is installed are turned on.

According to the teachings of the present invention, an agent software application 21 is provided to run on the client computer 20 to turn on all the drivers available in the operating system installed in the client computer 20 initially. Thus, when the client computer 20 is of a new type/brand or some hardware in the client computer 20 is changed, the drivers required for the new computer/hardware can be automatically utilized by the operating system, and the restoration/configuration process can be carried out smoothly with the downloaded restoration information.

Preferably, the agent software application 21 is downloaded from the server 10 over the data connection 12 together with the restoration information. This is particular advantageous when the client computer 20 is a new computer for replacement an original one.

In the foregoing embodiment of the invention, the remote server 10 downloads an agent to a client that turns on driver that would otherwise not normally be turned on the by the client computer.

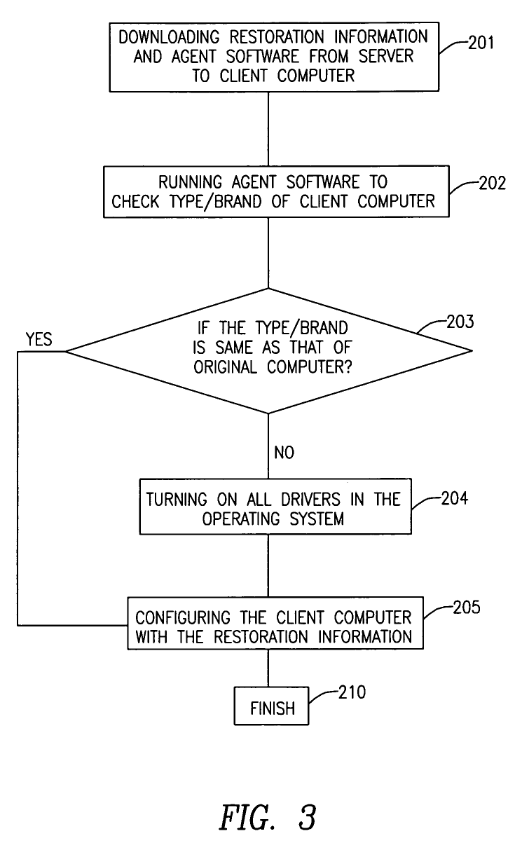

FIG. 3 illustrates a preferred embodiment of the configuration method for a replacement computer according to the present invention. When a replacement computer 20 replaces an original computer, the restoration information for the original computer saved in the storage 11, as well as an agent software application 21 according to the present invention, are downloaded from the server 10 to the client 20 at step 201. Then, the agent software application 21 runs on the client computer 20 to check whether the type and/or brand of the client computer 20 are the same as that of the original computer, at step 202. The information about the type and brand of the original computer is conveniently available in the restoration information. If, at step 203, it is determined that the replacement client computer 20 and the replaced original computer are of the same type and/or brand, it goes to step 205 to configure the client computer 20 with the restoration information. However, if it is found that the replacement client computer 20 and the replaced original computer are of a different type and/or brand, then the correct drivers can be used which are different from those on the replaced computer.

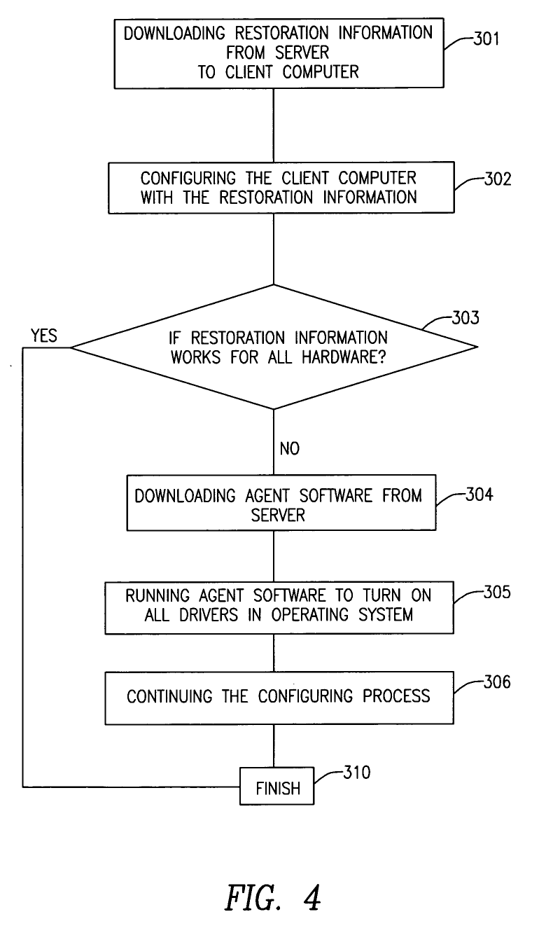

In another preferred embodiment as illustrated in FIG. 4, the client computer 20 is the same as that of the original computer from which the restoration information was backed up at the server 10. At step 201, the restoration information is downloaded from the server 10 to the client computer 20. Then configuration process starts at step 302 to configure the client computer 20 with the downloaded restoration information. If the restoration information works for all the hardware in the client computer 20, as determined at step 303, the configuration process continues until it finishes at step 310. However, if it is found that the restoration information does not work for all the hardware, at step 303, for example, if some hardware has been changed since the last backup of the restoration information, the configuration process pauses and an agent software application 21 is downloaded from the server 21 to the client computer 20, at step 304. Then the agent software application 11 runs to turn on all the drivers available in the operating system in the client computer 20, at step 305. After all the drivers are turned on, the configuration process resumes and continues, at step 306, until it finishes at step 310.

The above has described in detail the preferred embodiments of the present invention. However, it shall be appreciated that, without departing the spirit of the present invention, numerous variations, adaptations and modifications are available to people of ordinary skill in the art. For example, the agent software application may always turn on all the drivers in the client computer no matter whether there is a change in the hardware or computer type/brand, thus omitting the determination step 203, 303. The agent software application 21 may be installed in the client computer 20 from a disk, or it may have been installed in the client computer 20 in a previous restoration session. Checking the computer type/brand and turning on the drivers may be carried out by running two separate software applications instead of a single agent software application 21. Therefore, the scope of the present invention is intended to be defined solely by the accompanying claims.

What is claimed is:

1. A method for configuring a client computer with restoration information, comprising steps of:
providing said restoration information and an agent software application to said client computer;
turning on all drivers available in an operating system installed in said client computer by running said agent software application on said client computer; and
configuring said client computer with said restoration information.

2. The method of claim 1, wherein said restoration information is previously obtained from an original computer and stored in a server.

3. The method of claim 2, wherein said server is remotely located from said client computer and said original computer and communicates with said client computer and said original computer over a data connection.

4. The method of claim 3, wherein said restoration information is provided to said client computer over said data connection.

5. The method of claim 3, wherein said agent software is provided to said client computer over said data connection.

6. The method of claim 2, wherein said original computer is said client computer.

7. The method of claim 2, wherein said original computer is a computer to be replaced by said client computer.

8. The method of claim 2, further comprising a step of determining whether said original computer and said client computer have are same in type and brand.

9. The method of claim 8, wherein said step of turning on all said drivers is carried out only after said client computer and said original computer are found to be different in type or brand.

10. The method of claim 9, wherein said steps of determining are carried out by running said agent software application on said client computer.

11. The method of claim 2, further comprising a step of determining whether said restoration information works for all hardware installed in said client computer.

12. The method of claim 11, wherein said steps of determining are carried out by running said agent software application on said client computer.

13. The method of claim 12, wherein said step of turning on all said drivers is carried out only after it is found that said restoration information does not work for all hardware installed in said client computer.

14. An agent software application adapted to run on a computer to turn on all drivers available in an operating system in said computer.

15. The agent software application of claim 14, wherein it is further adapted to determine whether said computer is of the same type as that indicated in restoration information.

16. The agent software application of claim 14, wherein it is further adapted to determine whether restoration information works for all drivers available in an operating system of said client computer.

17. The agent software application of claim 14, wherein it is provided to said computer by a remote server over a data connection.

18. The agent software application of claim 16, wherein it is configured to turn on said drivers only after said client computer is found to be of different type from that indicated in said restoration information.

19. The agent software application of claim 17, wherein it is configured to turn on said drivers only after it is found that said restoration information does not work with all said drivers.

20. A system for configuring a client computer with restoration information, comprising:
a server for storing said restoration information obtained from an original computer and for providing said restoration information to said client computer; and
an agent software application adapted to run on said client computer to turn on all drivers available in an operating system in said client computer.

21. The system of claim 20, wherein said server is remotely located from said original computer and said client computer, and communicates with said computers over a data connection.

22. The system of claim 21, wherein said agent software application is adapted to determine whether said client computer and said original computer has a same type or brand.

23. The system of claim 21, wherein said agent software application is adapted to determine whether restoration information works for all hardware of said client computer.

24. The system of claim 21, wherein said agent software application is provided by said server to said client computer together with said restoration information over said data connection.

25. The system of claim 20, wherein said agent software application is configured to turn on said drivers only after said client computer is found to be of a different type or brand of said original computer.

26. The system of claim 20, wherein said client computer is said original computer.

27. The system of claim 20, wherein said client computer is a computer for replacement said original computer.
